(19) United States
(12) Patent Application Publication
(10) Pub. No.: US 2018/0087740 A1
(43) Pub. Date: Mar. 29, 2018

(54) LAMPSHADE, LAMP APPLYING THE SAME, AND LAMPSHADE FRAME

(71) Applicant: Lextar Electronics Corporation, Hsinchu (TW)

(72) Inventors: Kuan-Ting CHEN, Taipei City (TW); Chin-Hsing TSAI, Taichung City (TW); Daw-Heng Francis WONG, Hsinchu (TW)

(21) Appl. No.: 15/701,463

(22) Filed: Sep. 12, 2017

(30) Foreign Application Priority Data
Sep. 23, 2016 (TW) 105130831

(51) Int. Cl. F21V 1/26; F21V 1/14; F21V 1/12

(52) U.S. Cl. CPC F21V 1/26; F21V 1/02; F21V 1/12; F21V 1/143

(57) ABSTRACT

A lampshade includes an elongated body, a first frame, a second frame, a first slide rail, a second slide rail, and a first reflection sheet. The elongated body has a first end and a second end which are opposite to each other. The first frame is connected to the first end of the elongated body and has a first surface. The second frame is connected to the second end of the elongated body and has a second surface. The first and second surfaces face toward each other. The first and second slide rails are disposed on the first and second surfaces respectively. The first reflection sheet is disposed between the first and second frame. The first reflection sheet has a first side and a second side which are opposite to each other and respectively disposed in the first and second slide rail.

### RELATED APPLICATIONS

This application claims priority to Taiwanese Application Serial Number 105130831, filed Sep. 23, 2016, which is herein incorporated by reference.

### BACKGROUND

### Technical Field

The present disclosure relates to a lampshade, a lamp applying the same, and a lampshade frame.

### Description of Related Art

With the development of lighting technology, lighting devices have become necessary equipment for daily home life, travel, or camping. For example, when engaging in an outside activity in night, a lighting device can illuminate the surrounding environment, thereby increasing the safety and convenience for the activity. Therefore, the demand for the lighting device grows rapidly in the consumer market. In a field related to the lighting device, since a reflection-type lighting device has some advantages, it has become a common lighting device. For example, the reflection-type lighting device can be designed with beauty and light of weight. On the other hand, the light source of the reflection-type lighting device can be hidden therein such that the light source is not exposed, and thus the reflection-type lighting device can provide visual effects with soft and uniform illumination.

### SUMMARY

An aspect of the present disclosure is to provide a lamp including a lampshade, in which the lampshade includes an elongated body, slide rails, a first reflection sheet, and a second reflection sheet. The first reflection sheet and the second reflection sheet can slide toward the elongated body after being inserting into the corresponding slide rails, such that the first reflection sheet and the second reflection sheet can be detachably disposed between a first frame and a second frame. Therefore, when the reflection sheets of the lamp need to be replaced, a user may draw out and replace the reflection sheets by oneself. Furthermore, in the package including the elements of the un-assembled lamp, the first reflection sheet and the second reflection sheet can be stacked therein, thereby reducing the volume of the package.

An aspect of the present disclosure is to provide a lampshade including a elongated body, a first frame, a second frame, a first slide rail, a second slide rail, and a first reflection sheet. The elongated body has a first end and a second end which are opposite to each other. The first frame is connected to the first end of the elongated body and has a first surface. The second frame is connected to the second end of the elongated body and has a second surface, in which the first surface and the second surface face toward each other. The first slide rail is disposed on the first surface. The second slide rail is disposed on the second surface. The first reflection sheet is disposed between the first frame and the second frame. The first reflection sheet has a first side and a second side which are opposite to each other, and the first side and the second side are respectively disposed in the first slide rail and the second slide rail.

In some embodiments, extending paths of the first slide rail and the second slide rail are curved, and the first reflection sheet corresponds to the extending paths of the first slide rail and the second slide rail to become curved.

In some embodiments, the first surface has a first zone and a second zone which are symmetrical about the first end of the elongated body. The second surface has a third zone and a fourth zone which are symmetrical about the second end of the elongated body. The first zone faces toward the third zone, and the second zone faces toward the fourth zone. The first slide rail is disposed at the first zone of the first surface, and the second slide rail is disposed at the third zone of the second surface.

In some embodiments, the lampshade further includes a third slide rail, a fourth slide rail, and a second reflection sheet. The third slide rail is disposed at the second zone of the first surface. The fourth slide rail is disposed at the fourth zone of the second surface. Thea second reflection sheet is disposed between the first frame and the second frame. The second reflection sheet has a third side and a fourth side which are opposite to each other, and the third side and the fourth side are respectively disposed in the third slide rail and the fourth slide rail.

In some embodiments, the first reflection sheet and the second reflection sheet are two curved surfaces which are symmetrical about the elongated body.

In some embodiments, the first slide rail is extended from the first zone toward the second zone, and the third slide rail is extended from the second zone toward the first zone. The first slide rail and the second slide rail are connected to each other. The second slide rail is extended from the third zone toward the fourth zone, and the fourth slide rail is extended from the fourth zone toward the third zone. The second slide rail and the fourth slide rail are connected to each other.

In some embodiments, the first reflection sheet is extended from the first zone and the third zone toward the second zone and the fourth zone, and the second reflection sheet is extended from the second zone and the fourth zone toward the first zone and the third zone. The first reflection sheet and the second reflection sheet are connected to each other.

An aspect of the present disclosure is to provide a lamp including a lampshade and a light source. The light source is disposed at the lampshade and configured to provide at least one light beam toward the first reflection sheet, in which a vertical projection of the light source on the lampshade is present within the first reflection sheet.

An aspect of the present disclosure is to provide a lampshade frame including an elongated body, a first frame, a second frame, a first slide rail, and a second slide rail. The elongated body has a first end and a second end which are opposite to each other. The first frame is connected to the first end of the elongated body and has a first surface. The second frame is connected to the second end of the elongated body and has a second surface, in which the first surface and the second surface face toward each other. The first slide rail is disposed on the first surface. The second slide rail is disposed on the second surface, in which the first slide rail and the second slide rail have the substantial same extending path, and at least one portion of the extending path is curved.

### BRIEF DESCRIPTION OF THE DRAWINGS

FIG. 1A is a perspective view of a lamp according to some embodiments of the present disclosure;

FIG. 1B is a front view of the lamp of FIG. 1A viewed from a second frame toward a first frame;

FIG. 1C is a front view of the lamp of FIG. 1A viewed from the first frame toward the second frame;

FIG. 1D is a perspective view of the lamp of FIG. 1A after the first reflection sheet and the second reflection sheet are dismantled;

FIGS. 2A to 2D are schematic diagrams showing configurations of the first reflection sheet and the second reflection sheet of the lamp according to some embodiments of the present disclosure;

FIG. 3A is a perspective view of a lamp according to some embodiments of the present disclosure; and

FIG. 3B is a front view of the lamp of FIG. 3A viewed from the second frame toward the first frame.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

It will be understood that, although the terms first, second, third etc. may be used herein to describe various elements, components, regions, layers and/or sections, these elements, components, regions, layers and/or sections should not be limited by these terms.

An aspect of the present disclosure is to provide a lamp including a lampshade, in which the lampshade includes an elongated body, slide rails, a first reflection sheet, and a second reflection sheet. The first reflection sheet and the second reflection sheet may slide toward the elongated body after being inserted into the corresponding slide rails, such that the first reflection sheet and the second reflection sheet can be detachably disposed between a first frame and a second frame. Therefore, when the reflection sheets of the lamp need to be replaced, a user may draw out and replace the reflection sheets by oneself. Furthermore, in the package including the elements of the un-assembled lamp without, the first reflection sheet and the second reflection sheet can be stacked therein, thereby reducing the volume of the package.

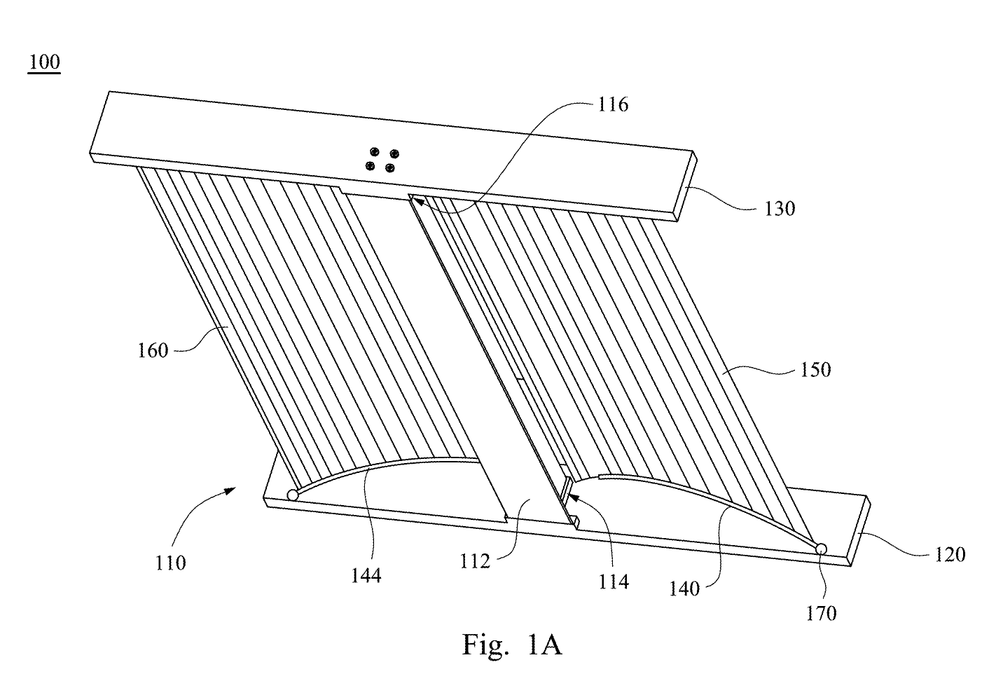

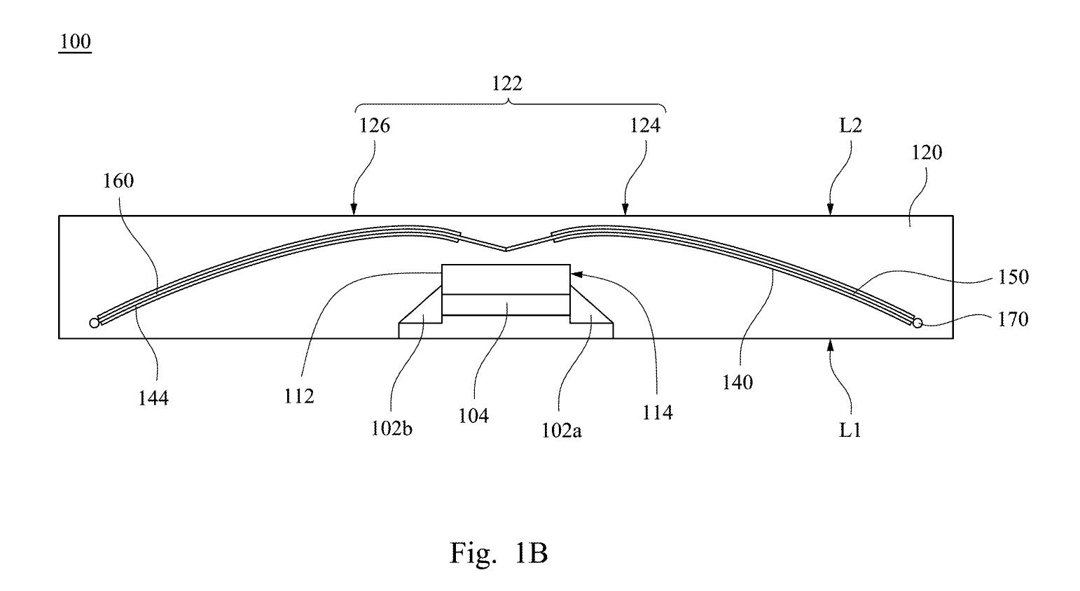

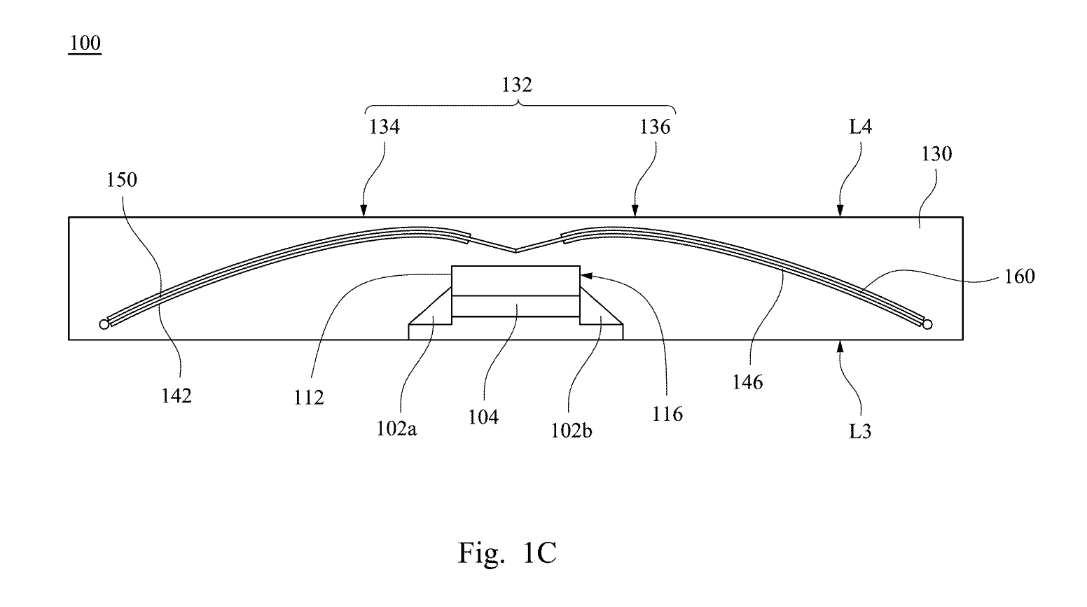

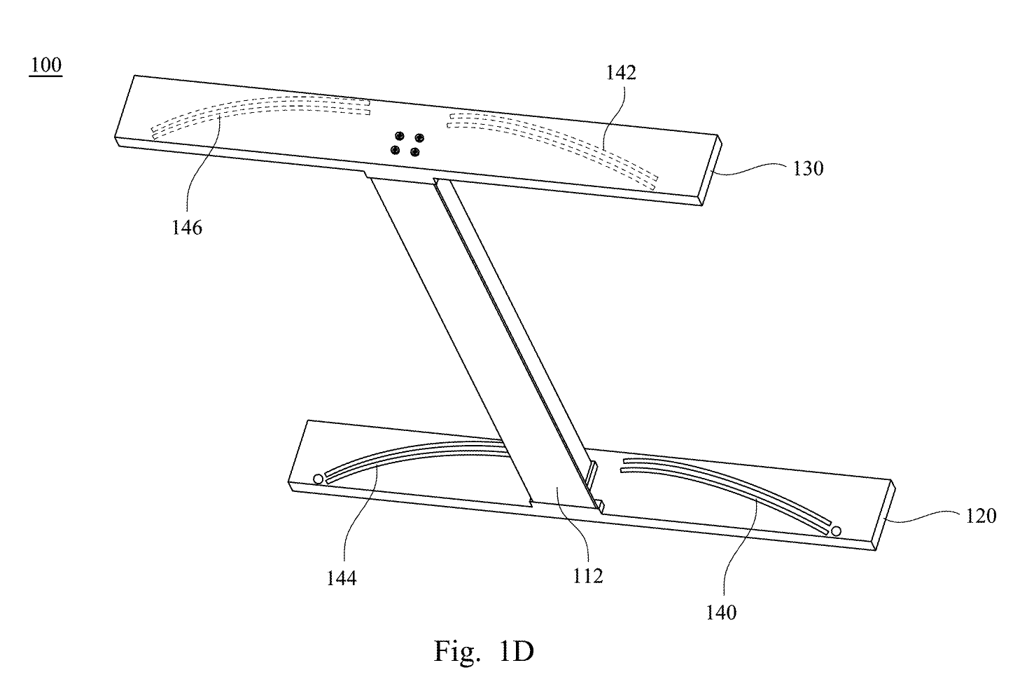

FIG. 1A is a perspective view of a lamp 100 according to some embodiments of the present disclosure. FIG. 1B is a front view of the lamp 100 of FIG. 1A viewed from a second frame 130 toward a first frame 120. FIG. 1C is a front view of the lamp 100 of FIG. 1A viewed from the first frame 120 toward the second frame 130. The lamp 100 includes a lampshade 110, light sources 102a and 102b, and a circuit board 104, in which the lampshade 110 includes a elongated body 112, a first frame 120, a second frame 130, a first slide rail 140, a second slide rail 142, a third slide rail 144, a fourth slide rail 146, a first reflection sheet 150, and a second reflection sheet 160. In order to make diagrams succinct, the light sources 102a and 102b and the circuit board 104 are illustrated in FIGS. 1B and 1C.

The elongated body 112 is bar-shaped and has a first end 114 and a second end 116 which are opposite to each other. The first frame 120 and the second frame 130 are respectively connected to the first end 114 and the second end 116 of the elongated body 112, and the first frame 120 and the second frame 130 are symmetrical about the elongated body 112. The elongated body 112, the first frame 120, and the second frame 130 illustrated in FIG. 1A can be three individual elements which are assembled together through fixed components. For example, the frames can be fixed at the ends of the elongated body 112 by at least one screw. In other embodiments, the elongated body 112, the first frame 120, and the second frame 130 can be integrated as one piece. In addition, the elongated body 112 illustrated in FIG. 1A is bar-shaped, but the shape of the elongated body 112 is not limited thereto. For example, in other embodiments, the elongated body 112 can be a cuboid, such as being plate-shaped or prism-shaped.

The first frame 120 has a first surface 122, and the second frame 130 has a second surface 132, in which the first surface 122 and the second surface 132 face toward each other. The first surface 122 of the first surface 122 has a first zone 124 and a second zone 126, in which the first zone 124 and the second zone 126 are symmetrical about the first end 114 of the elongated body 112. The second surface 132 of the second frame 130 has a third zone 134 and a fourth zone 136, in which the third zone 134 and the fourth zone 136 are symmetrical about the second end 116 of the elongated body 112. In addition, the first zone 124 and the third zone 134 face toward each other, and the second zone 126 and the fourth zone 136 face toward each other.

The first slide rail 140 and the third slide rail 144 are disposed on the first frame 120, and the second slide rail 142 and the fourth slide rail 146 are disposed on the second frame 130. The first slide rail 140 is disposed at the first zone 124 of the first surface 122 and the second slide rail 142 is disposed at the third zone 134 of the second surface 132, and the first slide rail 140 and the second slide rail 142 are opposite to each other. The third slide rail 144 is disposed at the second zone 126 of the first surface 122 and the fourth slide rail 146 is disposed at the fourth zone 136 of the second surface 132, and the third slide rail 144 and the fourth slide rail 146 opposite to each other.

Extending paths of the first slide rail 140 and the second slide rail 142 are two curves which are symmetrical to each other. In other words, the extending paths of the first slide rail 140 and the second slide rail 142 are substantial the same, and at least one portion of one of the extending paths is curved. Similarly to the first slide rail 140 and the second slide rail 142, extending paths of the third slide rail 144 and the fourth slide rail 146 are symmetrical to each other and are curved as well. Moreover, the first surface 122 of the first frame 120 is rectangular or square. The first surface 122 has a first edge L1 and a second edge L2, in which the first slide rail 140 and the third slide rail 144 are extended from the position near the first edge L1 toward the second edge L2. The second surface 132 of the second frame 130 is rectangular, in which the rectangle of the second frame 130 can correspond to the shape of the first frame 120. The second frame 130 has a third edge L3 and a fourth edge L4, in which the second slide rail 142 and the fourth slide rail 146 are extended from the position near the third edge L3 toward the fourth edge L4.

The first reflection sheet 150 can be rectangular or square, and has a first side and a second side which are opposite to each other. The first reflection sheet 150 is disposed between the first frame 120 and the second frame 130, in which the first side and the second side of the first reflection sheet 150 are respectively disposed in the first slide rail 140 and the second slide rail 142. In addition, in some embodiments in which the first reflection sheet 150 is rectangular, the first side and the second side of the first reflection sheet 150 can be a pair of shorter sides of the rectangle, and the pair of the shorter sides are respectively disposed in the first slide rail 140 and the second slide rail 142.

The second reflection sheet 160 can be rectangular or square, and has a third side and a fourth side which are opposite to each other. The second reflection sheet 160 is disposed between the first frame 120 and the second frame 130, in which the third side and the fourth side of the second reflection sheet 160 are respectively disposed in the third slide rail 144 and the fourth slide rail 146. Similarly to the first reflection sheet 150, in some embodiments in which the second reflection sheet 160 is rectangular, the third side and the fourth side of the second reflection sheet 160 can be a pair of shorter sides of the rectangle, and the pair of the shorter sides are respectively disposed in the third slide rail 144 and the fourth slide rail 146.

Furthermore, the first reflection sheet 150 is extended from the first zone 124 and the third zone 134 toward the second zone 126 and the fourth zone 136, and the second reflection sheet 160 is extended from the second zone 126 and the fourth zone 136 toward the first zone 124 and the third zone 134. The first reflection sheet 150 and the second reflection sheet 160 are connected to each other. In other words, the first reflection sheet 150 and the second reflection sheet 160 can be assembled as one reflection sheet by being connected to each other. In some embodiments in which the first reflection sheet 150 and the second reflection sheet 160 are connected to each other, bumps and grooves (not illustrated) can be disposed at the sides of the first reflection sheet 150 and the second reflection sheet 160 which face toward each other, such that the reflection sheet 150 and the second reflection sheet 160 can be connected to each other by inserting the bumps into the grooves.

That is, the first reflection sheet 150 and the second reflection sheet 160 can be inserted the corresponding slide rails, and slide toward the elongated body 112, so as to be located between the first frame 120 and the second frame 130. In other words, the first reflection sheet 150 and the second reflection sheet 160 assembled between the first frame 120 and the second frame 130 can be drawn out from the first frame 120 and the second frame 130 through the slide rails, such as the configuration shown in FIG. 1D, in which FIG. 1D is a perspective view of the lamp 100 of FIG. 1A after the first reflection sheet 150 and the second reflection sheet 160 are dismantled. Under such configuration, when the reflection sheets of the lamp 100 need to be replaced due to damage or other situations, a user can draw out and replace the reflection sheets by oneself. Alternatively, according to the required brightness of the lamp 100, a user can replace the reflection sheets with different material, so as to adjust the brightness provided by the lamp 100. Furthermore, the reflection sheet inserted into the slide rails can be fixed by fasteners 170, so as to prevent the reflection sheet from dropping from the slide rails. The fasteners 170 can be screws, latches or components which can confine the shift of the reflection sheet. In other words, the configuration illustrated in FIG. 1D can be considered as a lampshade frame. After the reflection sheets are inserted into the lampshade frame, a combination of the reflection sheets and the lampshade frame can become the lampshade 110.

On the other hand, the first reflection sheet 150 and the second reflection sheet 160 can be flexible and become curved after being inserted into the corresponding slide rails. For example, as shown in FIGS. 1A and 1D, since the extending paths of the first slide rail 140 and the second slide rail 142 are curves which are symmetrical to each other, after the first reflection sheet 150 is inserted into the first slide rail 140 and the second slide rail 142, the first reflection sheet 150 may correspond to the extending paths of the first slide rail 140 and the second slide rail 142 and become curved. In other words, the first side and the second side of the first reflection sheet 150 are deformed due to the constraint of the first slide rail 140 and the second slide rail 142, thereby making the first reflection sheet 150 curved. The curved first reflection sheet 150 has a concave and a convex which are opposite to each other, in which the concave faces toward the elongated body 112. Similarly to the first reflection sheet 150, the second reflection sheet 160 may correspond to the extending paths of the third slide rail 144 and the fourth slide rail 146 and become curved, such that the reflection sheet 150 and the second reflection sheet 160 are two curved surfaces which are symmetrical about the elongated body 112.

Reference is made back to FIGS. 1A, 1B, and 1C. The light sources 102a and 102b are connected to the elongated body 112, and the circuit board 104 is disposed in the elongated body 112. The light sources 102a and 102b may be light bars and are driven by the circuit board 104 to provide at least one light beam. In addition, although the light sources 102a and 102b illustrated in FIGS. 1B and 1C are connected to the elongated body 112, the light sources 102a and 102b in other embodiments may be disposed to be connected to the other portions of the elongated body 112. For example, in other embodiments, the light sources 102a and 102b are disposed at the lampshade 110, and a vertical projection of the light sources 102a and 102b on the lampshade 110 is located within the first reflection sheet 150 and the second reflection sheet 160.

The light sources 102a and 102b are configured to respectively provide light beams toward the first reflection sheet 150 and the second reflection sheet 160, in which the light beams provided by the light sources 102a and 102b may be reflected from the concaves of the first reflection sheet 150 and the second reflection sheet 160, such that the lamp 100 may provide the bottom side with illumination. In this regard, the lighting contribution of the illumination provided by the lamp 100 is controlled by the curve shape of the first reflection sheet 150 and the second reflection sheet 160. That is, once the bending curvature of the first reflection sheet 150 and the second reflection sheet 160 increases, the beam angle of the illumination provided by the lamp 100 may be decreased.

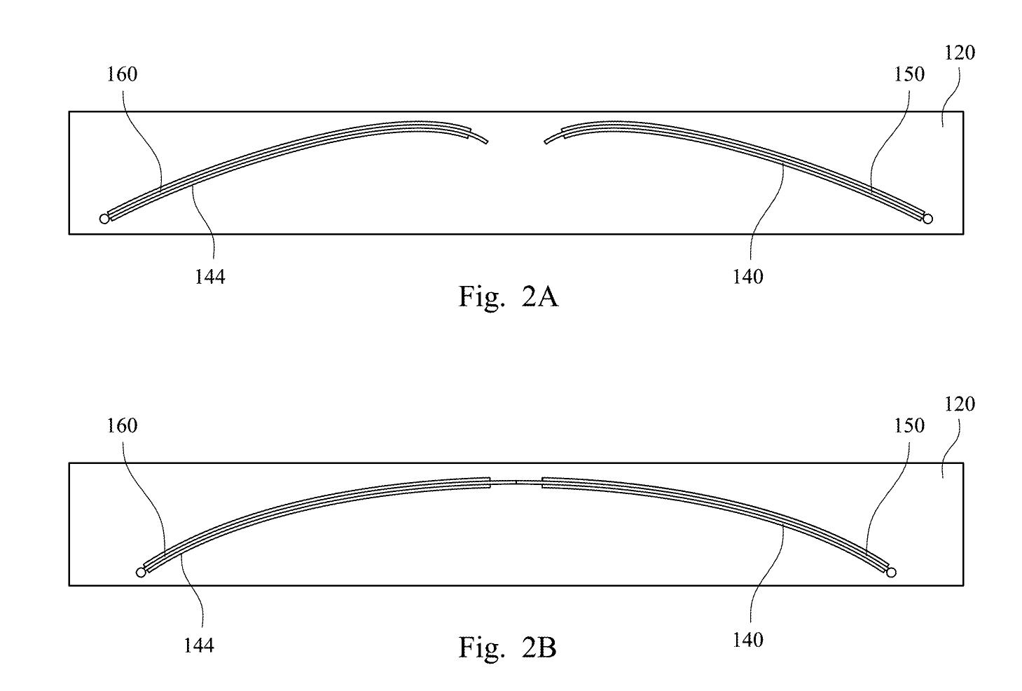

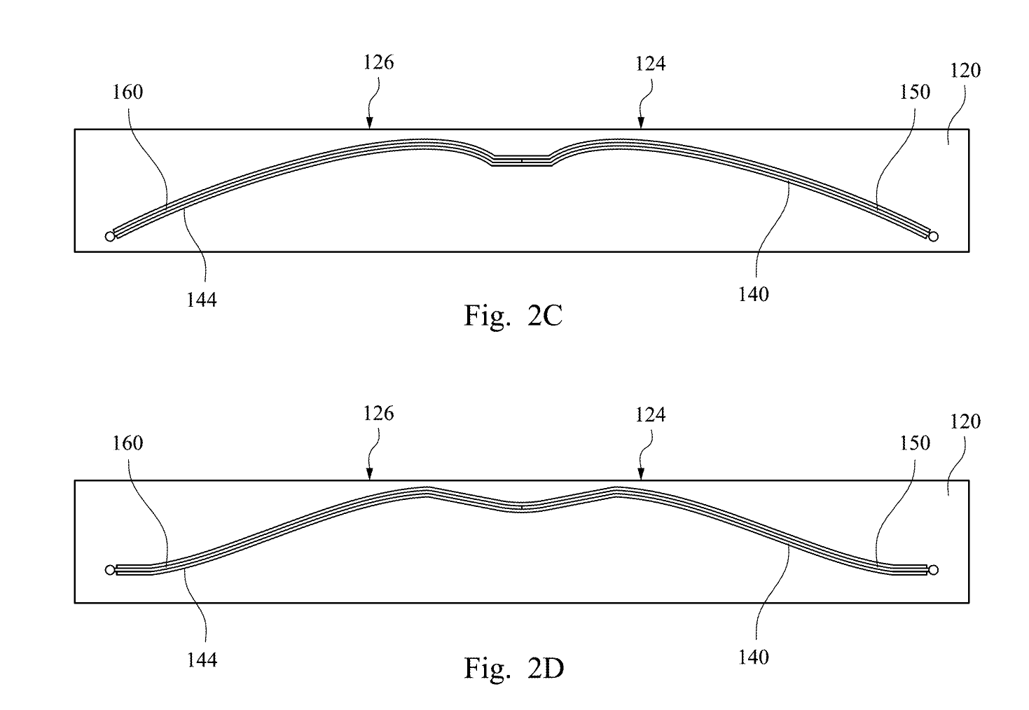

In the configuration of the lampshade 110, the curve shapes of the first reflection sheet 150 and the second reflection sheet 160 can be formed in accordance with the extending paths of the slide rails. For example, FIGS. 2A to 2D are schematic diagrams of the configurations of the first reflection sheet 150 and the second reflection sheet 160 of the lamp according to some embodiments of the present disclosure. As shown in FIGS. 2A to 2D, since the description herein is provided with respect to the relationship between the extending paths of the slide rails and the curve-shape of the first reflection sheet 150 and the second reflection sheet 160, only the first frame 120, the first slide rail 140, the third slide rail 144, the first reflection sheet 150, and the second reflection sheet 160 are illustrated in FIGS. 2A-2D.

As shown in FIGS. 2A and 2B, the first slide rail 140 and the third slide rail 144 are not connected. The shape of a combination of the first reflection sheet 150 and the second reflection sheet 160 illustrated in FIG. 2A is shown as a pair of wings. The shape of a combination of the first reflection sheet 150 and the second reflection sheet 160 illustrated in FIG. 2B is shown as separate curved surfaces. As shown in FIGS. 2A and 2B, the first slide rail 140 is extended from the first zone 124 toward the second zone 126 and the third slide rail 144 is extended from the second zone 126 toward the first zone 124, and the first slide rail 140 and the third slide rail 144 are connected to each other. The shape of a combination of the first reflection sheet 150 and the second reflection sheet 160 illustrated in FIG. 2C is shown as a pair of wings. The shape of a combination of the first reflection sheet 150 and the second reflection sheet 160 illustrated in FIG. 2D is shown as wave surfaces. In addition, although the second slide rail 142 (see FIG. 1C) and the fourth slide rail 146 (see FIG. 1C) are not illustrated in FIGS. 2C and 2D, a configuration of the second slide rail 142 and the fourth slide rail 146 is symmetrical to the configuration of the first slide rail 140 and the third slide rail 144. That is, the second slide rail 142 is extended form the third zone 134 (see FIG. 1C) toward the fourth zone 136 (see FIG. 1C) and the fourth slide rail 146 is extended from the fourth zone 136 toward the third zone 134, and the second slide rail 142 and the fourth slide rail 146 are connected to each other.

Since the curve-shape of the reflection sheets are formed in accordance with the extending paths of the slide rails, the same reflection sheets may be applied into the different lampshades 110 which provide different light contributions. In other words, since the reflection sheets disposed in the different lampshades 110 may have the same specifications, the reflection sheets can be mass produced, thereby reducing the manufacturing cost of the lampshade 110. On the other hand, since the reflection sheet applied into the lamp 100 is formed by assembling the first reflection sheet 150 and the second reflection sheet 160, a package including the elements of the un-assembled lamp 100 can be configured efficiently. For example, in the package including the elements of the un-assembled lamp 100, the first reflection sheet 150 and the second reflection sheet 160 can be placed by stacking therein, thereby reducing the volume of the package.

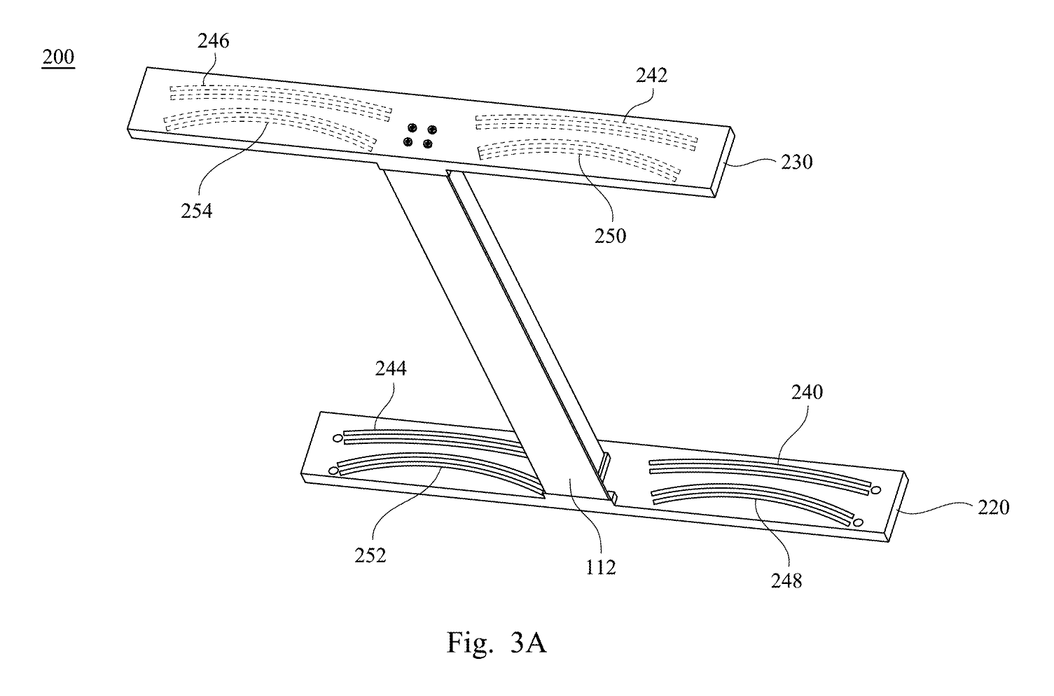

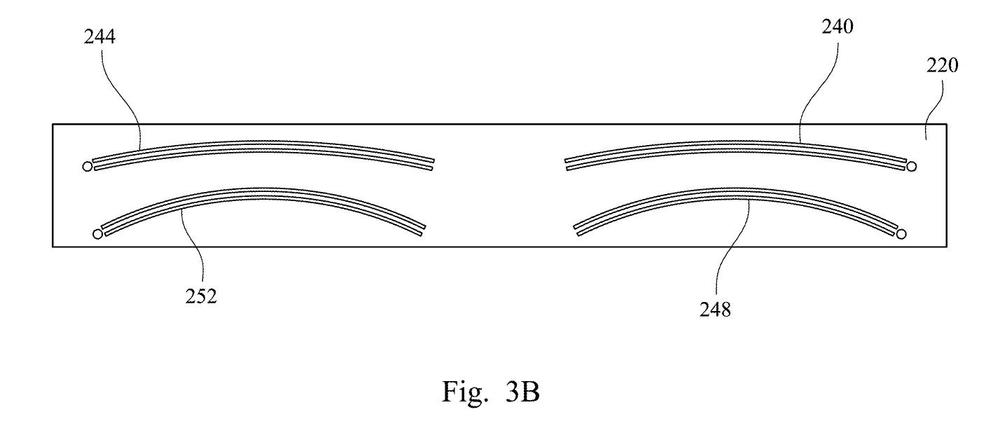

Furthermore, one single lampshade may have slide rails with more than one curvature, such that an user can change the illumination contribution by varying the curvature of the reflection sheet without needing to replacing the lampshade. For example, FIG. 3A is a perspective view of a lamp 200 according to some embodiments of the present disclosure, and FIG. 3B is a front view of the lamp 200 of FIG. 3A viewed from the second frame 230 toward the first frame 220. In addition, in order to make diagrams succinct, the reflection sheet is not illustrated in FIGS. 3A and 3B.

The lamp 200 includes a first slide rail combination and a second slide rail combination. The first slide rail combination includes a first slide rail 240, a second slide rail 242, a third slide rail 244, and a fourth slide rail 246. The second slide rail combination includes a fifth slide rail 248, a sixth slide rail 250, a seventh slide rail 252, and an eight slide rail 254. When two reflection sheets (i.e. for example, the first reflection sheet 150 and the second reflection sheet 160 illustrated in FIG. 1A) are disposed between a first frame 220 and a second frame 230 through the first slide rail combination, a curved surface formed by assembling the two reflection sheets together has a first curvature. When the same two reflection sheets are disposed between a first frame 220 and a second frame 230 through the second slide rail combination, a curved surface formed by assembling the two reflection sheets together has a second curvature, in which the first curvature is different from the second curvature.

With respect to the two slide rail combinations, under the condition that the curved surface formed by assembling the two reflection sheets together has the first curvature, the lamp 200 can provide illumination with a broader light contribution. Under the condition that the curved surface formed by assembling the two reflection sheets together has the second curvature, the lamp 200 can provide illumination with a concentrated light contribution. That is, by inserting the reflection sheets into the different slide rail combinations, the illumination contribution provide by the lamp 200 can be varied.

As described above, the lamp of the present disclosure includes lampshade, in which the lampshade includes the elongated body, the first frame, the second frame, the slide rails, the first reflection sheet, and the second reflection sheet. The first reflection sheet and the second reflection sheet can slide toward the elongated body through inserting into the corresponding slide rails, such that the first reflection sheet and the second reflection sheet can be detachably disposed between the first frame and the second frame. Therefore, when the reflection sheets of the lamp need to be replaced, a user can draw out and replace the reflection sheets by oneself. Furthermore, the curve-shape of the reflection sheets can be formed and changed in accordance with the extending paths of the slide rails. Therefore, the reflection sheets applied into the lamp may have the same specification, and the reflection sheets can be mass produced. On the other hand, in the package including the elements of the un-assembled lamp, the first reflection sheet and the second reflection sheet can be stacked therein, thereby reducing the volume of the package.

It will be apparent to those skilled in the art that various modifications and variations can be made to the structure of the present disclosure without departing from the scope or spirit of the invention. In view of the foregoing, it is intended that the present disclosure cover modifications and variations of the present disclosure provided they fall within the scope of the following claims.

What is claimed is:

1. A lampshade, comprising:
an elongated body having a first end and a second end which are opposite to each other;
a first frame connected to the first end of the elongated body and having a first surface;
a second frame connected to the second end of the elongated body and having a second surface, wherein the first surface and the second surface face toward each other;
a first slide rail disposed on the first surface;
a second slide rail disposed on the second surface; and
a first reflection sheet disposed between the first frame and the second frame, wherein the first reflection sheet has a first side and a second side which are opposite to each other, and the first side and the second side are respectively disposed in the first slide rail and the second slide rail.

2. The lampshade of claim 1, wherein extending paths of the first slide rail and the second slide rail are curved, and the first reflection sheet corresponds to the extending paths of the first slide rail and the second slide rail to become curved.

3. The lampshade of claim 1, wherein the first surface has a first zone and a second zone which are symmetrical about the first end of the elongated body, and the second surface has a third zone and a fourth zone which are symmetrical about the second end of the elongated body, wherein the first zone faces toward the third zone, and the second zone faces toward the fourth zone, wherein the first slide rail is disposed at the first zone of the first surface, and the second slide rail is disposed at the third zone of the second surface.

4. The lampshade of claim 3, further comprising:
a third slide rail disposed at the second zone of the first surface;
a fourth slide rail disposed at the fourth zone of the second surface; and
a second reflection sheet disposed between the first frame and the second frame, wherein the second reflection sheet has a third side and a fourth side which are opposite to each other, and the third side and the fourth side are respectively disposed in the third slide rail and the fourth slide rail.

5. The lampshade of claim 4, wherein the first reflection sheet and the second reflection sheet are two curved surfaces which are symmetrical about the elongated body.

6. The lampshade of claim 4, wherein the first slide rail is extended from the first zone toward the second zone, the third slide rail is extended from the second zone toward the first zone, and the first slide rail and the second slide rail are connected to each other;
wherein the second slide rail is extended from the third zone toward the fourth zone, the fourth slide rail is extended from the fourth zone toward the third zone, and the second slide rail and the fourth slide rail are connected to each other.

7. The lampshade of claim 4, wherein the first reflection sheet is extended from the first zone and the third zone toward the second zone and the fourth zone, the second reflection sheet is extended from the second zone and the fourth zone toward the first zone and the third zone, and the first reflection sheet and the second reflection sheet are connected to each other.

8. A lamp, comprising:
a lampshade, comprising:
an elongated body having a first end and a second end which are opposite to each other;
a first frame connected to the first end of the elongated body and having a first surface;
a second frame connected to the second end of the elongated body and having a second surface, wherein the first surface and the second surface face toward each other;
a first slide rail disposed on the first surface;
a second slide rail disposed on the second surface; and
a first reflection sheet disposed between the first frame and the second frame, wherein the first reflection sheet has a first side and a second side which are opposite to each other, and the first side and the second side are respectively disposed in the first slide rail and the second slide rail; and
at least one light source disposed at the lampshade and configured to provide at least one light beam toward the first reflection sheet, wherein a vertical projection of the light source on the lampshade is located within the first reflection sheet.

9. The lamp of claim 8, wherein extending paths of the first slide rail and the second slide rail are curved, and the first reflection sheet corresponds to the extending paths of the first slide rail and the second slide rail to become curved.

10. The lamp of claim 8, wherein the first surface has a first zone and a second zone which are symmetrical about the first end of the elongated body, and the second surface has a third zone and a fourth zone which are symmetrical about the second end of the elongated body, wherein the first zone faces toward the third zone, and the second zone faces toward the fourth zone, wherein the first slide rail is disposed at the first zone of the first surface, and the second slide rail is disposed at the third zone of the second surface.

11. The lamp of claim 10, further comprising:
a third slide rail disposed at the second zone of the first surface;
a fourth slide rail disposed at the fourth zone of the second surface; and
a second reflection sheet disposed between the first frame and the second frame, wherein the second reflection sheet has a third side and a fourth side which are opposite to each other, and the third side and the fourth side are respectively disposed in the third slide rail and the fourth slide rail.

12. The lamp of claim 11, wherein the first reflection sheet and the second reflection sheet are two curved surfaces which are symmetrical about the elongated body.

13. The lamp of claim 11, wherein the first slide rail is extended from the first zone toward the second zone, the third slide rail is extended from the second zone toward the first zone, and the first slide rail and the second slide rail are connected to each other;
wherein the second slide rail is extended from the third zone toward the fourth zone, the fourth slide rail is extended from the fourth zone toward the third zone, and the second slide rail and the fourth slide rail are connected to each other.

14. The lamp of claim 11, wherein the first reflection sheet is extended from the first zone and the third zone toward the second zone and the fourth zone, the second reflection sheet is extended from the second zone and the fourth zone toward the first zone and the third zone, and the first reflection sheet and the second reflection sheet are connected to each other.

15. A lampshade frame comprising:
an elongated body having a first end and a second end which are opposite to each other;
a first frame connected to the first end of the elongated body and having a first surface;
a second frame connected to the second end of the elongated body and having a second surface, wherein the first surface and the second surface face toward each other;
a first slide rail disposed on the first surface; and
a second slide rail disposed on the second surface, wherein the first slide rail and the second slide rail have the substantial same extending path, and at least one portion of the extending path is curved.

16. The lampshade frame of claim 15, wherein the first surface has a first zone and a second zone which are symmetrical about the first end of the elongated body, and the second surface has a third zone and a fourth zone which are symmetrical about the second end of the elongated body;
wherein the first zone faces toward the third zone, and the second zone faces toward the fourth zone;
wherein the first slide rail is disposed at the first zone of the first surface, and the second slide rail is disposed at the third zone of the second surface, wherein the lampshade further comprises a third slide rail and a fourth slide rail, and the third slide rail and the fourth slide rail are respectively disposed at the second zone of the first surface and the fourth zone of the second surface.
